(19) United States
(12) Patent Application Publication
(10) Pub. No.: US 2004/0245382 A1
(43) Pub. Date: Dec. 9, 2004

(54) Aircraft which employs hydrogen as fuel

(76) Inventor: Yoshio Nozaki, Inazawa-City (JP)

Correspondence Address: Yoshio Nozaki, 89, Saiwai-Cho, Inazawa-City, Aichi-Ken, JP

(21) Appl. No.: 10/419,302

(22) Filed: Apr. 22, 2003

(51) Int. Cl. B64B 1/24

(52) U.S. Cl. 244/53 R

(57) ABSTRACT

An aircraft comprises fuel tanks for storing liquid fuel, water reservoirs for storing reforming water, reforming devices for generating a high temperature steam by heating the reforming water from the water reservoirs to generate hydrogen by the chemical reaction of the generated steam with the liquid fuel from the fuel tanks, and engines of generating the thrust by the combustion of the hydrogen thus generated in the reforming devices. The utilization of the aircraft allows the fuel cost to be reduced about ¼ times, compared with that arisen in the conventional jet engine aircrafts. The liquid fuel of hydrogen also allows the emission of pollution material to be greatly reduced.

### BACKGROUND OF THE INVENTION

1. Field of the Invention

The present invention relates to an aircraft, which is capable of making a flight with a fuel of hydrogen obtained in a chemical reaction of a liquid fuel with a high temperature steam in the aircraft.

2. Description of the Related Art

An ingredient of the exhaust gas emitted from an engine of an aircraft is known as an essential factor in depleting the ozone layer in the atmosphere. As a result, the development of an aircraft capable of making a flight with a fuel of liquid hydrogen started on 1990 in the cooperation work of Daimler Benz Aerospace Airbus Co. Ltd and Tupolev Design Division. On the basis of the results obtained in the work of development, a trial modification of an A310 type passenger airplane by Airbus Co. Ltd. started on 2000. The aircraft manufactured by way of trial is called Cryoplane, and this nomenclature is also used herein. An imaginative drawing of the Cryoplane at its completion is shown in FIG. 3, where reference numerals 9, 10, 12, 13, mean the body, main wing, horizontal stabilizer and vertical stabilizer, respectively. Each engine 18 is coupled to the main wing 10 via a corresponding pylon 17, and liquid nitrogen tanks 15 are mounted on the upper part 14 of the body 10. The liquid nitrogen tanks 15 are surrounded by a thermal insulation material 16.

Main items in the modification and the flight performance are as follows:

The body is extended in the longitudinal length by 11 m and the upper part of the body is enlarged to store a tank for liquid hydrogen.

| | |
|---|---|
| Flight Performance: | 319 passengers accommodated |
| Flying Range: | 5,000 km |
| Cruising Altitude: | 9,150 m-10,000 m. |

The aircraft using liquid hydrogen as a fuel is accompanied with the following drawbacks:

(1) As for the comparison of liquid hydrogen with the jet fuel in the same heating power.

(a) The volume of the liquid hydrogen is 4.2 times larger than that of the jet fuel. In other words, liquid hydrogen requires an about 4 times larger volume in the fuel tank for the Cryoplane than the jet fuel.

(b) In accordance with the experimental study, the liquid hydrogen is stored in the fuel tank at −253° C. under a pressure of 1.5 kg/cm². As a result, it is necessary to mount a thermal insulation material having an about 400 mm thickness onto the periphery of the fuel tank for the liquid hydrogen, thereby causing the space for the fuel tank to be further increased.

In a passenger plane and a transport plane, almost all the amount of jet fuel is normally stored inside the Boxbeam of the main wing. However, the fuel of liquid hydrogen is stored at a pressure of 1.5 kg/cm², and the volume thereof is more than 4 times greater than that of the jet fuel, as described above in the item (b). The Boxbeam of the main wing is constituted in the form of a box having substantially straight planes, and therefore it is not suitable for a fuel vessel used at a pressure of 1.5 kg/cm². Accordingly, it is necessary to store a fuel tank having more than 4 times greater volume in the body, compared with the conventional tank for the jet fuel. When, therefore, an aircraft using hydrogen as a fuel is newly designed, it is conceivable that liquid hydrogen is stored preferably in two divided tanks, which are disposed respectively in the front and rear of the passenger cabin. The aircraft, Cryoplane, manufactured by way of trial is constructed by modifying the A310 type passenger plane, which is made by Airbus Co. Ltd, and it is prevailingly used. A fuel tank for liquid hydrogen is installed in a space which is provided by enlarging the upper part of the body in the Cryoplane, i.e., the existing A310 type passenger plane.

Generally, a person skilled in the art is able to predict the above matters with ease. However, there is a difficult and unexpected problem that the fuel cost in the fuel of liquid hydrogen is five times greater than that in the jet fuel. In other words, a five times greater fuel cost is required if the person tries to obtain the calorific value of the jet fuel from the liquid hydrogen. The specific properties of the liquid hydrogen and jet fuel are numerically shown in the following table, and a tentative calculation will be made for the fuel cost.

| | Liquid Hydrogen | | Jet Fuel | |
|---|---|---|---|---|
| Calorific value | 28,600 | kcal/kg | 10,500 | kcal/kg |
| Specific Gravity | 0.0708 | kg/l | 0.80 | kg/l |
| Price per Volume | 100 | yen/l | 80 | yen/l |

From these numerical values, it follows that the price per unit weight is 100/0.0708=1,412 yen/kg and 80/0.800=100 yen/kg for the liquid hydrogen and the jet fuel, respectively. Taking the calorific values into account, the fuel cost, i.e., the price per calorific value is 1,412/28,600=49.4×10⁻³ yen/kcal and 100/10,500=9.52×10⁻³ yen/kcal in the liquid hydrogen and jet fuel, respectively. Accordingly, the ratio of the fuel cost of the jet fuel to that of the liquid hydrogen becomes 5.2. It is generally known that the fuel cost is about 25% of the direct navigation cost. Therefore, a fivefold increase in the fuel cost causes the direct navigation cost to be increased by two times. Moreover, a twofold increase in the direct navigation cost causes the transportation fare to be increased by one and half times. This is a problem, which cannot be easily solved.

In addition, a comparison of the flight performance was made by Lockheed Aircraft Co. on 1988, as for both the aircraft using the fuel of liquid hydrogen (Aircraft A) and the aircraft using the jet fuel (Aircraft B) under the same conditions that the number of travelers is 400; the cruising speed is 0.85M; and the flying range is 10,190 km, and the results are as follows:

| | Aircraft A | Aircraft B |
|---|---|---|
| Maximum Take-off Weight | 168,830 kg | 232,060 kg |
| Loadable Weight of Fuel | 21,620 kg | 72,630 kg |

From the above numerical values, it follows that the ratio of the fuel consumption of the aircraft A to that of the aircraft B is 21,620/72,630=0.298. On the other hand, the ratio of the fuel cost per unit weight for the aircraft A to that for the aircraft B is (100/0.0708)/(80/0.800)=14.1. Accordingly, the ratio of the fuel cost for the aircraft A to that for the aircraft B is 0.298×14.1=4.20. The fuel cost ratio calculated on the basis of the loadable weight is smaller than the above value 5.2 calculated on the basis of the calorific value. This difference is due to the following fact:

The relative weight of liquid hydrogen corresponding to the same calorific value as that of the jet fuel is (10,500 kcal/kg)/(28,600 kcal/kg)=0.37 in the unit of the jet fuel weight. As a result, if the liquid hydrogen having the same calorific value as the jet fuel is loaded on an aircraft, the weight of the fuel is decreased by 0.37 times and thereby the maximum take-off weight of the aircraft is also decreased. It can be stated, therefore, that the fuel consumption of an aircraft decreases with the decrease of the maximum take-off weight of the aircraft. Furthermore, the increase in both the direct navigation cost and the transportation fare is estimated, assuming that the fuel cost is 4.2 times as much as that in the case when the liquid hydrogen is used. It may be ascertained that the direct navigation cost is increased by about 1.8 times and the transportation fare is increased by about 1.4 times.

In conjunction with the above, the present inventor still cannot forget the image in which the German airship, Hindenburg, was burned out due to the hydrogen firing. In fact, almost all of the passengers hesitate to sit down on a seat in the vicinity of hydrogen fuel inside the main body of an aircraft.

### SUMMARY OF THE INVENTION

Accordingly, it is an object of the present invention to provide an aircraft, which is capable of reducing the fuel cost as well as of avoiding the damage due to the fire in the aircraft using liquid hydrogen as a fuel.

To attain the above object, the following measures are provided:

In a first aspect of the invention, an aircraft comprises at least one fuel tank for storing liquid fuel; at least one water reservoir for storing reforming water; at least one reforming device for generating a high temperature steam by heating the reforming water from the water reservoir to generate hydrogen by the chemical reaction of the generated steam with the liquid fuel from the fuel tank; and at least one engine of generating the thrust by the combustion of the hydrogen thus generated in the reforming device.

In a second aspect of the invention, the aircraft further includes an auxiliary power unit capable of being energized by the liquid fuel.

In a third aspect of the invention, the aircraft further includes at least one generator and at least one battery, wherein an electric power generated by the generator is supplied to the reforming device or the battery.

In a fourth aspect of the invention, the heating of the reforming water from the reservoir 3 is carried out by utilizing the heat to which the electric power from the generator is transformed.

In a fifth aspect of the invention, the heating of the reforming water is carried out by burning part of liquid fuel with aid of the power charged in the battery.

In a sixth aspect of the invention, the liquid fuel is preferably the jet fuel.

In a seventh aspect of the invention, a profan engine is used for the engine.

In an eight aspect of the invention, the liquid fuel and reforming water are stored in containers inside the main wing and vertical stabilizer.

From the present invention, the following advantages may be obtained:

In accordance with the first aspect of the invention, hydrogen used as a fuel is generated in the aircraft with the aid of the chemical reaction of the liquid fuel with the high temperature water in the reforming device. As a result, it is no longer necessary to supply the fuel of hydrogen from the ground. Because the hydrogen is used as a fuel, the emission of pollution material can be greatly reduced, as similarly to the Cryoplane, thereby making it possible to prevent the ozone layer from depleting in the atmosphere. In addition, the risk of fire can be significantly reduced, because the hydrogen as a fuel is not stored directly in the aircraft and only the liquid fuel of generating the hydrogen is stored therein.

In accordance with the second and third aspects of the invention, the power for the auxiliary power unit can be effectively supplied from the liquid fuel.

In accordance with the fourth and fifth aspects of the invention, the heating of the reforming device can be carried out by utilizing the energy from the liquid fuel.

In accordance with the sixth aspect of the invention, the liquid fuel is the jet fuel, which can be supplied from the all of the existing airports. Accordingly, the fuel cost can be reduced about ¼times, compared with that arisen in the conventional jet engine aircrafts.

In accordance with the seventh aspect of the invention, the profan engine having higher fuel efficiency enables the reduction in the flying range to be compensated.

In accordance with the eighth aspect of the invention, the liquid fuel and reforming water are stored in the main wing and vertical stabilizer, as similarly to those in the conventional jet engine aircraft.

### BRIEF DESCRIPTION OF THE DRAWINGS

FIG. 1 is a perspective view of an aircraft in an embodiment of the invention;

FIG. 2 is a perspective view of a fuel/power system in the aircraft according to the invention;

FIG. 3 is a perspective view of an aircraft manufactured in trial according to the prior art, i.e., Cryoplane;

FIG. 4 is a block diagram schematically showing a fuel/power system in a conventional fuel cell automobile; and

FIG. 5 is a perspective view of an aircraft in another embodiment of the invention.

### DESCRIPTION OF THE PREFERRED EMBODIMENTS

Referring now to the accompany drawings, the invention will be described in detail.

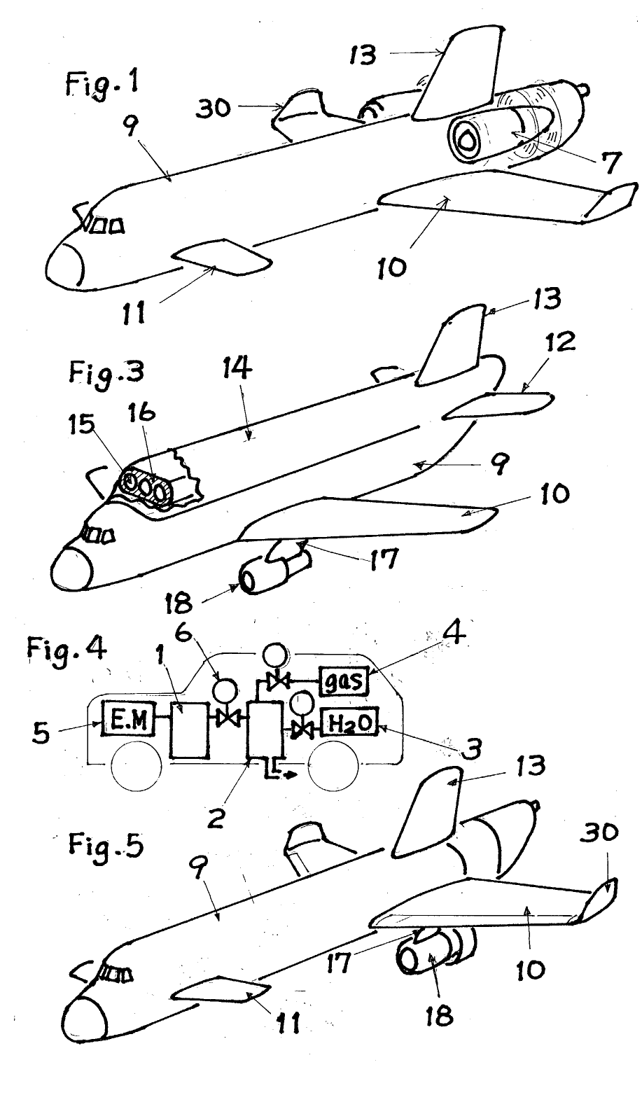

FIG. 1 is a perspective view of an aircraft in an embodiment of the invention, where reference numerals 9, 10, 11 and 13 mean the body, main wing, front wing and vertical stabilizer of the aircraft, respectively. Engines 7 are mounted on the rear part of the body 9, and each main wing 10 is provided with a winglet 30, which is greatly efficient for increasing the flying range.

FIG. 5 is a perspective view of an aircraft in another embodiment of the invention, where reference numerals 9, 10, 11, 13 and 30 are the same as those in FIG. 1. In this case, however, each prop-fan engine 18 is mounted onto the main wing 10 via corresponding pylon 17.

In the present invention, a liquid fuel, such as jet fuel, is loaded on the aircraft, which is shown in FIG. 1 or 5. Moreover, hydrogen is generated in the aircraft with the aid of the chemical reaction of the liquid fuel with a steam at a high temperature, and the hydrogen thus generated is used as a fuel for the flight of the aircraft.

The method for generating hydrogen in the above procedure has been developed in an automobile having a fuel cell system in order to supply hydrogen thereto. In order to clearly explain the fuel cell system in the aircraft according to the invention, an example of an automobile having substantially the same fuel cell system is shown in FIG. 4. FIG. 4 is a schematic block diagram of a fuel/power system in such an automobile. The automobile is equipped with a fuel cell unit 1, a reforming device 2, a reservoir 3 for reforming water used to prepare a high temperature steam and a tank 4 for liquid fuel. The automobile is further equipped with a motor 5 for moving the vehicle and a valve 6 for isolating the fuel cell unit 1 from the reforming device 2.

The reforming device 2 is formed as a container in which a liquid fuel supplied from the tank 4 is mixed with a reforming water from the reservoir 3 to form hydrogen with the aid of the chemical reaction with each other, in which case, the reforming water supplied from the reservoir 3 is heated up to generate a steam at a high temperature, and the liquid fuel supplied from the tank 4 is injected into the steam by spraying to make a flight.

In accordance with the invention, either the jet fuel or DME (dimethylether) is used as the liquid fuel supplied from the tank 4. It is necessary that the required amount of the reforming water corresponds to a 2.5 times larger weight than that of the jet fuel. In the case of DME, the required amount of the reforming water corresponds to a 1.2 times larger weight than that of DME. In the following description, the jet fuel is mostly used as the liquid fuel supplied from the tank 4.

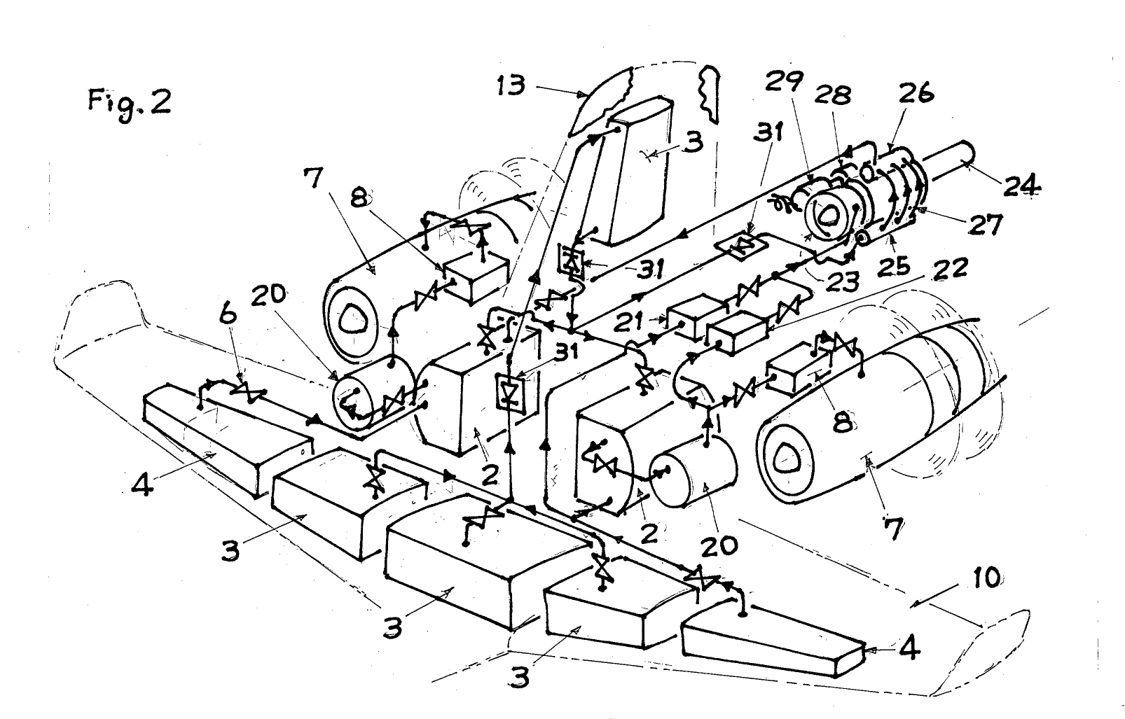

FIG. 2 is a perspective view of the fuel and power system in the aircraft according to the invention. Reservoirs 3 for reforming water and tanks 4 for liquid fuel are disposed in the main wing 10. Another reservoir 3 for reforming water is disposed in the vertical stabilizer 13. The reservoirs 3 and the tanks 4 are both connected to reforming devices 2 via corresponding values. As a result, reforming water is supplied from the reservoirs 3 to the reforming devices 2 via check valves 31. Part of the liquid fuel is supplied from the tanks 4 to the reforming devices 2 via supply shut-off valves 6, and the other part of the liquid fuel is supplied from the tanks 4 to a hydrogen fuel flow control apparatus 21 for an auxiliary power unit (APU) 23. Hydrogen generated in the reforming devices 2 is supplied to hydrogen reservoirs 20 via corresponding valves. Part of hydrogen is further supplied from the hydrogen reservoirs 20 to the APU 23 via a liquid fuel flow control apparatus 22. The other part of hydrogen is supplied from the hydrogen reservoirs 20 to engines 7 via another hydrogen fuel flow control apparatus 8. Moreover, reference numerals 24, 25, 26, 27, 28 and 29 mean an exhaust duct, reforming water reservoir, steam reservoir, pipe for heating the reforming water, decelerator and power generator or dynamo, respectively.

The reforming device 2 is disposed preferably in the front of the APU 23 on the rear side of the body 9. This is because the reforming device 2 has a larger volume, and there is no space in which the reforming device 2 is accommodated. The volume of the reforming device capable of supplying the fuel to the engine of the A310-300 type passenger plane, which is an original of the Cryoplane, is estimated about 40 m³ per engine. There is no substantial limitation on the arrangement of the other apparatuses.

As shown in FIG. 2, it is somewhat useful, if the mutual distance of the reforming device 2, the reservoir 3 for reforming water, the tank 4 for the liquid fuel and the engines 7 is further reduced. Referring to FIG. 2, the function of the system will be described.

The liquid fuel in the tank 4 disposed in the inside of the main wing 10 is supplied to the APU 23 by the liquid fuel flow control apparatus 21, and then the APU 23 is started. The APU 23 activates the generator 29, and the electric power obtained is used to heat the reforming water in the reforming device 2, thereby enabling the steam to be generated at a high temperature. The steam thus generated is reacted with the liquid fuel supplied from the tank 4 in the reforming device 2, so that hydrogen is generated therein. The hydrogen thus generated is supplied to engines 7 via the hydrogen reservoir 20 and the hydrogen fuel flow control apparatus 8. After starting the engines 7, the electric power generated by the generator 29 is used to heat the reforming device 2, in which case, the generator 29 is energized by the engines 7. After starting the engines 7, the hydrogen fuel flow control apparatus 22 is used to switch the fuel for driving the APU 23 to hydrogen.

In another embodiment, the electric power can be supplied from the generator 29 to batteries (not shown), and the high temperature steam is generated by heating the reforming water with the electric power from the batteries (not shown), in which case, the heating is carried out, using part of liquid fuel in the reforming device 2.

As described above, in the aircraft using hydrogen as a fuel in accordance with the invention, it is no longer necessary to receive hydrogen from the ground. Accordingly, the aircraft using hydrogen as a fuel in accordance with the invention makes it possible to land at any airport equipped with no installation for charging hydrogen. In other words, it is unnecessary to newly equip with an installation for charging and/or freezing hydrogen in any airport. In order to realize the flight of an aircraft using liquid hydrogen as the fuel, i.e., the Cryoplane, it was conceivable that each airport was equipped with an installation for charging and/or freezing hydrogen. The cost of constructing and maintaining such an installation for charging and/or freezing hydrogen in main airports all over the world is extremely expensive. The storage and charging of the jet fuel are conventionally carried out at a normal temperature and at the atmospheric pressure. On the contrary, it is necessary to preserve the liquid hydrogen at −253° C. under a pressure of 1.5 kg/cm² in the storage and charging thereof. In addition, it is noted that the volume of the liquid hydrogen having the same calorific value as the jet fuel is four times larger than that of the jet fuel. As a result, the aircraft according to the invention is advantageous, because it no longer requires the charging of hydrogen fuel from the ground.

The heat source for obtaining the high temperature steam depends on the partial combustion of fuel (gasoline or methanol) in the case of an automobile, whereas an electric power can be used either to partially burn the fuel or to obtain the entire heat for generating the steam in the case of an aircraft. It is an optional selection in the stage of development which method is to be employed.

Gasoline (C₈H₁₈), methanol (CH₃OH) and DME (CH₃OCH₃) were investigated as a liquid fuel for the automobile having the fuel cell system. As a result, hydrogen of 20 kg was obtained from 60-liter gasoline (44.4 kg), whereas hydrogen of 10 kg was obtained from 60-liter methanol (47.4 kg). The amount of obtained hydrogen was approximately identical with the calculated value. For instance, C₈H₁₈+16H₂O→25H₂+8CO₂ in the case of gasoline.

The jet fuel as liquid fuel has the same chemical component as kerosene (molecular formula: CH₁₂H₂₆). In this case, the following chemical reaction takes place: C₁₂H₂₆+24H₂O→32H₂+12CO₂. From the molecular formula, it follows that hydrogen of 20.7 kg can be obtained from 60-liter jet fuel (48 kg).

Similarly, the amount of hydrogen obtainable from DME (CH₃OCH₃) can be calculated. From the chemical reaction of CH₃OCH₃+3H₂O→6H₂+2CO₂, it follows that hydrogen of 12.5 kg can be obtained from DME of 48 kg.

Estimation is made for the jet fuel, which provides a greater amount of hydrogen generated per a unit weight in the liquid fuel. It can be recognized that DME requires a 1.7 times greater weight than the jet fuel in order to obtain the same amount of hydrogen. If, however, the price of the jet fuel is increased about two times, compared with the current price, it may be advantageous to use DME. The temperature of the steam has to be set at an high temperature (hereinafter referred to as reforming temperature) at which the chemical reaction of the liquid fuel from the tank 4 with the steam from the reservoir 3 takes place. The reforming temperature of the jet fuel ranges from 800° C. to 900° C., whereas the reforming temperature of DME is expected about 300° C. The exact reforming temperature of DME is not known. However, the reforming temperature of methanol having a chemical formula similar to that of DME ranges from 200° C. to 300° C.

The fuel cost of methanol is about three times larger than that of the jet fuel. However, it is advantageous that the reforming temperature obtainable from methanol is as low as 200 ° C.-300° C. Accordingly, the liquid fuel of methanol provides a simple structure for the reforming device and further requires a reduced thermal energy for generating a high temperature steam.

As described above, one part of the jet fuel from the tank 4 and 2.5 part of the reforming water from the reservoir 3 can be used as a fuel in the aircraft according to the invention. Consequently, such a fuel greatly reduces the risk of firing, compared with the liquid fuel of hydrogen. Moreover, the tank 4 for the jet fuel and the reservoir 3 for the reforming water can be stored in the inner space of the Boxbeam of the main wing. In conjunction with the above, the risk of firing can be further reduced, if the reservoir 3 for the reforming water is disposed at a position below the floor of the passenger cabin in the vicinity of the center area of the main wing 10.

It is estimated that the obtainable amount of natural crude oil corresponds to that in the consumption during forty and several years. Accordingly, there is a possibility that the price of the jet fuel will be increased by several times after ten and several years. To overcome such a problem, synthetic oil was produced from the crude material of coal and/or natural gas in Germany, using the Fisher-Toropush method in the 1920s. In fact, 60 and several tons of such synthetic oil were produced per one year to support the military capacity during Word War II in Germany, using this method. At present, the cost of the synthetic oil is 1.4 to 1.6 times greater than that of the natural oil. As for the cost, it is possible to use the synthetic oil as a fuel for an aircraft. Taking into account the fuel consumption during one year, it is estimated that the obtainable amounts of coal and natural gas, which are both used as a raw material for producing the synthetic oil, correspond to the amounts of the fuel consumption during about 150 years and about 100 years for the coal and natural gas, respectively.

In the following, the flying range of the aircraft according to the invention, wherein it uses hydrogen as a fuel, will be estimated.

Firstly, the calorific value of hydrogen obtainable from the chemical reaction of the liquid fuel with the high temperature steam in accordance with the invention is calculated, and then it is compared with the calorific value obtained directly from the combustion of the jet fuel. From the numerical values, the flying range can be estimated for the two types of fuel.

It has already been described that the hydrogen having a 20.7 kg weight can be obtained in the chemical reaction of the liquid fuel (jet fuel) having a weight of 48 kg with the high temperature steam. In this case, the calorific value of the hydrogen having the 20.7 kg weight becomes 20.7 kg×28,600 kcal/kg=592,020 kcal. The weight of required reforming water is 2.5 times larger than that of the liquid fuel; 2.5×48 kg=120 kg. In summary, the total weight becomes liquid fuel: 48 kg+reforming water: 120 kg=168 kg, and therefore, a heat of 592,020 kcal is obtainable from the liquid fuel and reforming water, whose total weight is 168 kg.

On the contrary, the heat obtained by the combustion of the jet fuel having a weight of 168 kg becomes 168 kg×10,500 kcal/kg=1,764,000 kcal.

As a result, the ratio of the flying range in the aircraft according to the invention using the 168 kg weight for the fuel system (reforming water+liquid fuel) to that in the aircraft using the jet fuel having a weight of 168 kg becomes 592,020 kcal/1,764,000 kcal=0.34. In the former case, it should be noted that the consumption of the liquid fuel is 48 kg in the total weight of 168 kg, and therefore the rate of consumption of liquid fuel is (48/168)=0.29. Hence, the reduction rate in the flying range is 0.34 and the reduction rate in the fuel consumption is 0.29. This implies a substantial 1.17−fold increase in the flying range relative to the liquid fuel consumption. The flying range decreases in a rate of 0.34, whereas the fuel cost per flight distance also decreases in a somewhat smaller rate.

In the following, the numerical values for functional parameters are listed for the Boeing B777-200LR passenger plane, which has the maximum flying range of 16,300 km at present:

| | |
|---|---|
| Maximum Take-Off Weight | 333,390 kg |
| Fuel Weight | 161,800 kg |
| Static Thrust per Engine | 49,900 kg |
| Fuel Consumption Rate at a Static | 0.330 kg/kg · p · h |
| Thrust of 49,900 kg | |
| Fuel Consumption at a Static | 16,467 kg |
| Thrust of 49,900 kg | (= 49.900 kg × 0.330 kg/kg · p · h) |
| The Number of Passengers/Payload | 301/22,000 kg |
| | (payload = 301 × 73 kg) |

On the basis of these parameters, the flying range of the aircraft according to the invention will be calculated in trial, when the system of supplying hydrogen as a fuel is introduced into the Boeing B777-200LR type passenger plane.

In the estimation, it is assumed that the weight of the reforming device 2 is 20.160 kg×2=40,320 kg. In this case, the factor of 2 results from the fact that an aircraft is equipped with two engines. It is further assumed that the total weight of the reforming water and the liquid fuel is 161,800 kg, which is the same as the fuel weight in the Boeing B777-200LR type passenger plane.

As described above, the flying range for the aircraft according to the invention is about 34% of that for the aircraft using the jet fuel, when the total weight of the reforming water and liquid fuel is the same as that of the jet fuel. When applying the present invention to the B777-200LR passenger plane, the flying range is reduced in 16,300 km×0.34=5,540 km. A flying range of 5000 km allows the aircraft to make a flight between Paris and New York.

In the following, in order to avoid a reduction in the payload of the passenger plane, it is necessary to decrease the total weight of the reforming water and the liquid fuel by the weight corresponding to the weight of the reforming device 2. In other words, in order to avoid the reduction of the payload under the condition that the maximum take-off weight is preserved within a restricted range, it is necessary to decrease the total weight of the substantial fuel (the reforming water+the liquid fuel): 161,800 kg by the weight of the reforming device 2: 40,320 kg. The flying range, in which the weight of the reforming device is taken into account, becomes about 4,160 km, as explained below.

The flying range, which is determined from the weight of 121,480 kg=the total weight (161,800 kg) of the liquid fuel and the reforming water−the weight of the reforming device (40,320 kg), is 16,300 km×0.34×(161,800−40,320/161,800)=4160 km.

As described above, the flying range of the aircraft according to the invention decreases from 16,300 km to 4,160 km. In view of this fact, the flying range can be increased by employing one of the following three different type fuel-efficient engines. The percentage (%) in the following table means the reduction rate in the fuel consumption relative to that of the turbo fan engine in the conventional airplane, B777-200LR type passenger plane, in the case when the fuel-efficient engine is employed.

| Reduction | | |
|---|---|---|
| Rate of Fuel | | |
| Consumption | Maker of Engine | Name of Engine |
| 15% | Pratte and Whitney | ADP |
| | Co. Ltd. | (Advanced Ducted Prop-fan |
| | | Engine) |
| 30% | Allison/NASA | UDF |
| | | (Unducted Fan Engine: Model 578) |
| 51.5% | Soviet Union, Progress | DV27 |
| | Ltd. | (Unducted Prop-fan Engine) |

It is noted that, when such a fuel-efficient engine is employed, both the capacity (the ability of generating hydrogen) and the weight of the reforming device 2 decrease in proportion to the reduction of the fuel consumption rate.

Subsequently, the weight of the reforming device 2, which is decreased by employing the fuel-efficient engine, is calculated in trial.

In the case when the ADP engine having a 15% reduction rate of the fuel consumption is employed, the weight of the reforming device is 20,160×2×(1.00−0.15)=34,270 kg.

In the case when the UDF engine having a 30% reduction rate of the fuel consumption is employed, the weight of the reforming device is 20,160×2×(1.0−0.3)=28,220 kg.

In the case when the DV-27 engine having a 51.5% reduction rate of the fuel consumption is employed, the weight of the reforming device is 20,160×2×(1.00−0.515)=19,550 kg.

The employment of such an engine having a reduced fuel consumption rate causes the flying range to be increased:

In the ADP engine, the flying range becomes 1.00/(1.00−0.15)=1.18 times larger.

In the UFD engine, the flying range becomes 1.00/(1.00−0.30)=1.43 times larger.

In the DV-27 engine, the flying range becomes 1.00/(1.00−0.515)=2.06 times larger.

Accordingly, the employment of such an engine having a reduced fuel consumption rate provides a decrease in the weight of the reforming device, and such reduction in the weight of the reforming device eventually provides an increase in the flying range. Accordingly, a composite increase in the flying range can be calculated as follows:

To increase the flying range, a prop fan engine having reduced fuel consumption is employed, i.e., the ADP engine, which is developed by Pratte and Whitney Co. Ltd. and has a 15% reduction in the fuel consumption, is employed. A 15% reduction in the fuel consumption causes the weight of the reforming device to be decreased by 15%. In addition, the flying range increases by (1/0.85) times, and therefore the increase in the flying range becomes 5,140 km. That is, the flying range obtained by employing the ADP engine having a 15% reduction in the fuel consumption is 16,300 km×0.34×(161,800−34,270/161,800)/(1.00−0.15)=5,140 km.

In next, the case of employing the Model 578 engine, which is developed by Allison/NASA and has a 30% reduction in the fuel consumption, is discussed. Similarly, the weight of the reforming device is decreased by 30% and further the flying range increases by (1/0.7) times and it becomes 6,540 km. That is, the flying range obtained by employing the UDF engine having a 30% reduction in the fuel consumption is 16,300 km×0.34×(161,800−28,220/161,800)/(1.00−0.30)=6,540 km.

Finally, a brief discussion is made for the case when the DV-27 type engine having a 51.5% reduction in the fuel consumption is employed in an aircraft, as the Antonov, An-70 type transport plane is equipped with the engine. Similarly, the weight of the reforming device is decreased by 51.5% and further the flying range increases by (1/0.485) times and it becomes 10,050 km. That is, the flying range obtained by employing the DV-27 engine having a 51.5% reduction in the fuel consumption is 16,300 km×0.34×(161,800−19,550/161,800)/(1.00−0.515)=10,050 km.

As described above, an employment of the ADP engine having a 15% reduction in the fuel consumption provides a flying range of 5,140 km, and therefore makes it possible to make a transatlantic flight between Paris and New York.

Furthermore, an employment of the UDF engine having a 30% reduction in the fuel consumption provides a flying range of 6,540 km, and therefore makes it possible to make a transpacific flight via Hawaii.

Incidentally, it is noted that the UDF engine provides vibration and noise to some extent, when it is mounted onto the body of the plane. Accordingly, a drawback in the usage of this type engine is that a measure to suppress such a trouble is required.

Finally, the ground for supporting the estimation of the weight of the fuel-reforming device 2 is described.

The reforming device 2 has been developed to supply hydrogen to a fuel cell in a fuel cell automobile, and it is known that a hydrogen generation rate of 750 l/min is required to activate a motor having a power of 75 kW, and that the weight of a reforming device capable of providing such a hydrogen generation rate is 20 kg.

The calorific value of hydrogen supplied at a rate of 750 l/min is identical with a jet fuel weight of 9.8 kg/h. In other words, a reforming device for generating hydrogen at a rate of 750 l/min is capable of activating a turbo fan engine having a fuel consumption of 9.8 kg/h. This value is extremely different from the fuel consumption of the engine installed in the B777-200 LR type passenger plane, i.e., 16,467 kg/h. Accordingly, it is difficult to estimate the weight of a reforming device for supplying hydrogen to the engine in the B777-200 LR type passenger plane. Although any further data are not known, the weight of the reforming device for an engine in the above passenger plane can be estimated to be 20,160 kg, using the data on the weight of the existing reforming device used in the automobile:

(16,467 kg/h/9.8 kg/h)×20 kg×0.6=20,160 kg.

The details of the above estimation are as follows:

If hydrogen emanated from a reforming device for generating hydrogen at a rate of 750 l/min is entirely used, it provides the same amount of heat as that obtained when a jet fuel is burned at a rate of 9.8 kg/hr. The weight of the reforming device for generating hydrogen at the rate of 750 l/min is 20 kg, and the fuel consumption of the engines in the B777-200 LR type aircraft is 16,467 kg. Accordingly, the fuel consumption of the engines in the B777-200 LR type aircraft is 1,680 (=16,467 kg/hr/9.8 kg/hr) times larger than the hydrogen generated from the reforming device for generating hydrogen at a rate of 750 l/min. Assuming that the weigh of the reforming device is proportional to the fuel consumption, the weight of the reforming device supplying the fuel to the engines in the B777-200 LR type aircraft becomes 1,680×20 kg=33,600 kg.

It may be assumed that the weight of the reforming device per unit volume (20 kg in the hydrogen generating rate of 750 l/min) decreases with the increase of the volume. The reduction rate in the weight versus the volume can be determined from the data on the reciprocal (gasoline) engine in the following manner:

The weight of a 100 HP class engine per unit power (horse power=HP) is 0.9 kg/HP and the weight of a 4800 HP class engine per unit power is 0.5 kg/HP. Accordingly, the reduction rate in the weight versus the power becomes 0.5 kg/HP/0.9 kg/HP=0.55. Based on this reduction rate, the reduction rate in the weight versus the volume can be estimated 0.6 when the volume of the reforming device increases 1,360 times. Hence, the weigh of the reforming device necessary for energizing the engines in the B777-200 LR type aircraft can be estimated 20 kg×1,680×0.6=20,160 kg.

As described above, the aircraft according to the invention uses hydrogen as a fuel and no longer requires supplemental charge of hydrogen from the ground in flight. In addition, the aircraft according to the invention is capable of making a long distance flight at a reduced fuel cost.

What is claimed is:

1. An aircraft comprising:
at least one fuel tank for storing liquid fuel;
at least one water reservoir for storing reforming water;
at least one reforming device for generating a high temperature steam by heating said reforming water from said at least one water reservoir to generate hydrogen by the chemical reaction of the generated steam with said liquid fuel from said at least one fuel tank; and
at least one engine of generating the thrust by the combustion of the hydrogen thus generated in said at least one reforming device, which is characterized in that;
(a) said aircraft further comprises an auxiliary power unit capable of being energized by said liquid fuel,
(b) said aircraft further comprises at least one generator and at least one battery, wherein an electric power generated by said at least one generator is supplied to said at least one reforming device or said at least one battery,
(c) the heating of the reforming water in said aircraft is carried out with a heat to which the electric power from said at least one generator is transformed,
(d) the heating of the reforming water in said aircraft is carried out by burning part of the liquid fuel with aid of the power charged in said at least one battery, and
(e) the said liquid fuel in said aircraft is the jet fuel.

2. An aircraft comprising:
at least one fuel tank for storing liquid fuel;
at least one water reservoir for storing reforming water;
at least one reforming device for generating a high temperature steam by heating said reforming water from said at least one water reservoir to generate hydrogen by the chemical reaction of the generated steam with said liquid fuel from said at least one fuel tank; and at least one engine of generating the thrust by the combustion of the hydrogen thus generated in said at least one reforming device,
wherein said at least one engine is a prop-fan engine.
